(19) United States
(12) Patent Application Publication
(10) Pub. No.: US 2011/0017430 A1
(43) Pub. Date: Jan. 27, 2011

(54) THERMAL MODULE

(75) Inventors: ZHI-SHENG LIAN, Shenzhen City (CN); JIN-BIAO LIU, Shenzhen City (CN); GEN-PING DENG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu- Cheng (TW)

(21) Appl. No.: 12/566,693

(22) Filed: Sep. 25, 2009

(30) Foreign Application Priority Data
Jul. 21, 2009 (CN) 200910304613.3

(51) Int. Cl. F28D 15/04; G06F 1/20; F28F 7/00

(52) U.S. Cl. 165/104.26; 165/122; 165/185

(57) ABSTRACT

A thermal module includes a mounting plate, a centrifugal fan with a fin assembly arranged at an air outlet thereof, and a heat pipe connected the fin assembly with the heat mounting plate. The centrifugal fan includes a fan housing and an impeller rotatably received in the fan housing. The fan housing is disposed immediately neighboring to the mounting plate and mounted to a lateral side of the mounting plate via a securing structure formed between the fan housing and the mounting plate. The fan housing consists of a base and a cover. The base is made of a plastic material.

### BACKGROUND

1. Technical Field

The present disclosure relates to thermal modules, and more particularly to a thermal module which has a low manufacture cost.

2. Description of Related Art

With continuing development of the electronic technology, electronic components such as CPUs (central processing units) generate more and more heat required to be dissipated immediately. Therefore, thermal modules are widely used to help dissipating heat of the electronic components.

A typical thermal module includes a mounting plate, a fan housing integrally formed with the mounting plate, an impeller rotatably received in the fan housing, a fin assembly mounted at an air outlet of the fan housing, a heat absorbing plate mounted at a bottom side of the mounting plate, and a heat pipe connecting the fin assembly with the heat absorbing plate. The mounting plate secures the heat absorbing plate onto the electronic component to absorb heat therefrom. The mounting plate and the fan housing are integrally formed from a metallic material by die-casting. The mould of the die-casting has a great difficulty in design, and the material cost of the thermal module is relatively high. Therefore, the thermal module has a high manufacture cost.

For the foregoing reasons, a thermal module which can overcome the described shortcomings is desired.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an assembled, isometric view of a thermal module according to a first embodiment of the present disclosure.

FIG. 2 is an exploded, isometric view of the thermal module of FIG. 1.

FIG. 3 is an isometric view of a mounting plate of the thermal module of FIG. 2, as viewed form a bottom side thereof.

FIG. 4 is an assembled, isometric view of a thermal module according to a second embodiment of the present disclosure.

FIG. 5 is an exploded, isometric view of the thermal module of FIG. 4.

FIG. 6 is an isometric view of a cover of the thermal module of FIG. 5, as viewed form a bottom side thereof.

### DETAILED DESCRIPTION

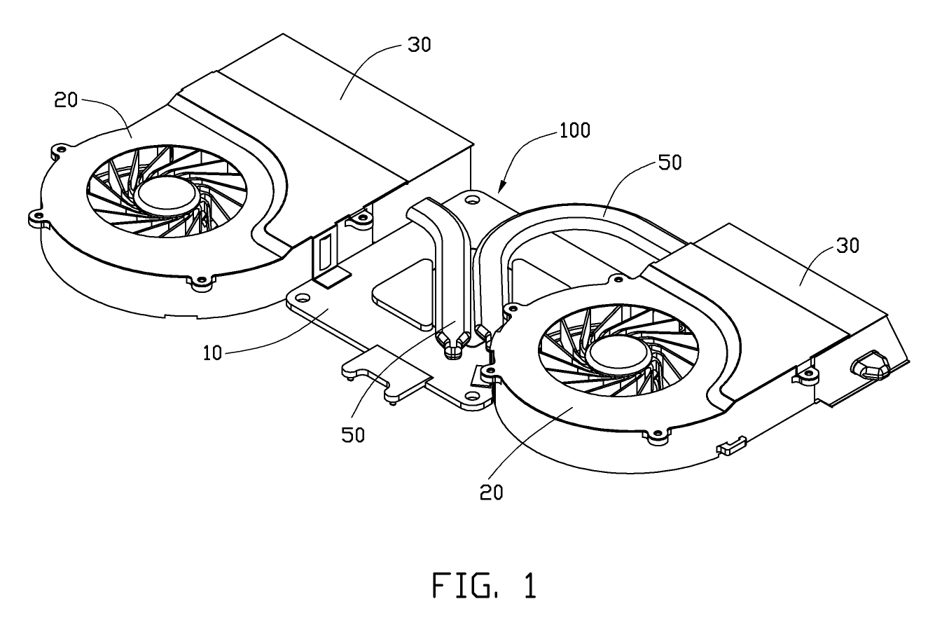

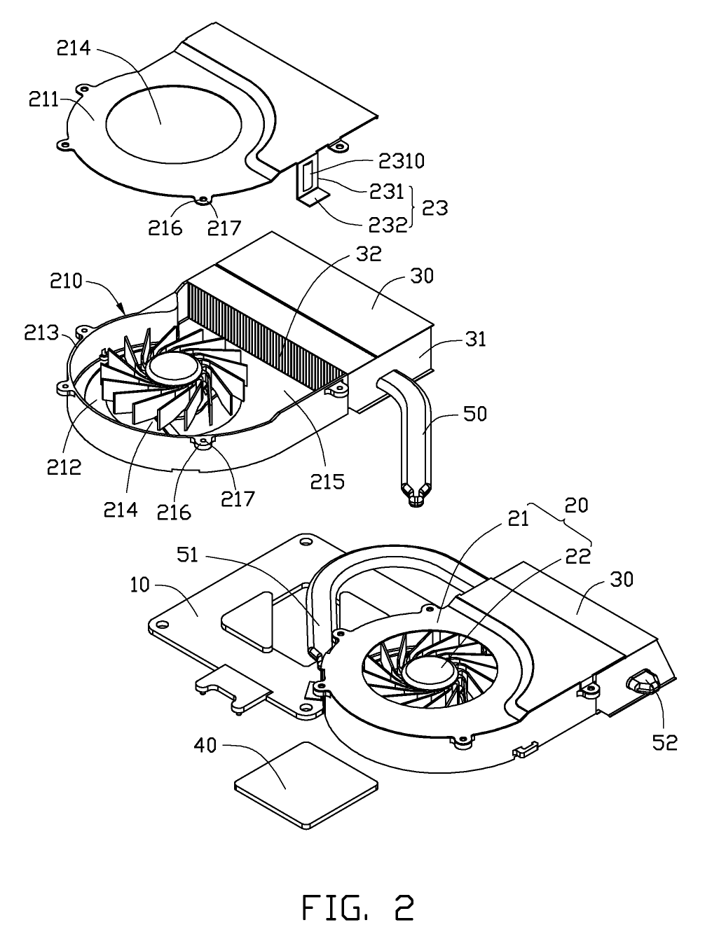

Referring to FIGS. 1 and 2, a thermal module 100 according to a first embodiment of the present disclosure includes a mounting plate 10, two centrifugal fans 20 respectively mounted on two opposite lateral sides of the mounting plate 10, two fin assemblies 30 respectively mounted at air outlets 215 of the two centrifugal fans 20, a heat absorbing plate 40 mounted on a bottom surface of the mounting plate 10, and two heat pipes 50 each of which connects the heat absorbing plate 40 with a corresponding fin assembly 30. The thermal module 100 is typically suitable for use in a portable electronic device, such as a portable computer to dissipate heat of a heat-generating electronic component, such as a CPU in the portable computer.

The two centrifugal fans 20 have structures identical to each other. The two centrifugal fans 20 are respectively mounted on left and right lateral sides of the mounting plate 10. Each of the two centrifugal fans 20 includes a fan housing 21 and an impeller 22 rotatably received in the fan housing 21. The fan housing 21 includes a base 210 and a cover 211 covering on the base 210. The cover 211 and the base 210 cooperatively enclose the impeller 22 therein. The base 210 is made of a plastic material, such as PBT (polybutylece terephthalate). The base 210 includes a bottom plate 212 and a side wall 213 extending upwardly from a periphery of the bottom plate 212. The bottom plate 212 faces the cover 211. The side wall 213 is located between the cover 211 and the bottom plate 212. The cover 211 and the bottom plate 212 each define an air inlet 214 which faces the impeller 22. The side wall 213 defines the air outlet 215, which is perpendicular to the air inlets 214. The cover 211 protrudes a plurality of ears 216 outwardly and horizontally from an outer edge thereof. The side wall 213 protrudes a plurality of ears 216 outwardly and horizontally from a top thereof corresponding to the ears 216 of the cover 211. Each of the ears 216 defines a through hole 217 therein. The through hole 217 of each of the ears 216 of the cover 211 aligns with the through hole 217 of a corresponding ear 216 of the side wall 213 for receiving a fastener, such as a screw to secure the cover 211 on the base 210. The cover 211 is made of a metallic material. The cover 211 includes a securing flake 23 formed at the outer edge thereof. The securing flake 23 is substantially L-shaped. The securing flake 23 includes an arm portion 231 extending downwardly from the outer edge of the cover 211 and a securing portion 232 extending perpendicularly and outwardly from a bottom end of the arm portion 231 towards the mounting plate 10. The arm portion 231 protrudes a rib 2310 outwardly therefrom. The rib 2310 is strip-shaped and extends linearly from a top end of the arm portion 231 towards the bottom end of the arm portion 231. The rib 2310 increases a mechanical strength of the arm portion 231. The securing portion 232 is parallel to the cover 211. The securing portion 232 is secured on the mounting plate 10, to thereby secure the centrifugal fan 20 onto the mounting plate 10. In this embodiment the securing portion 232 of the securing flake 23 is welded to the mounting plate 10. Alternatively, fastening means such as screw or clip can be adopted to secure the securing portion 232 to the mounting plate 10.

The two fin assemblies 30 are respectively mounted at the air outlets 215 of the two centrifugal fans 20. Each of the two fin assemblies 30 includes a plurality of fins 31 stacked together. An air passage channel 32 is formed between every two adjacent fins 31. The air passage channels 32 of the fin assembly 30 communicate with the air outlet 215 of the centrifugal fan 20.

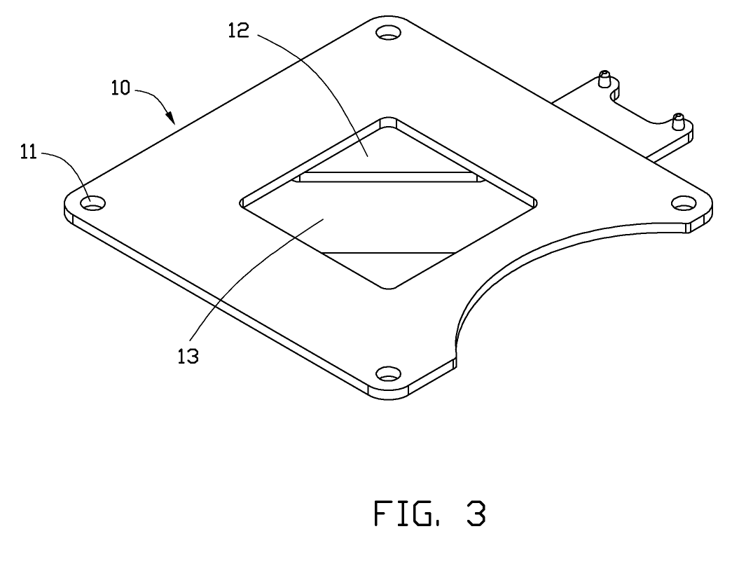

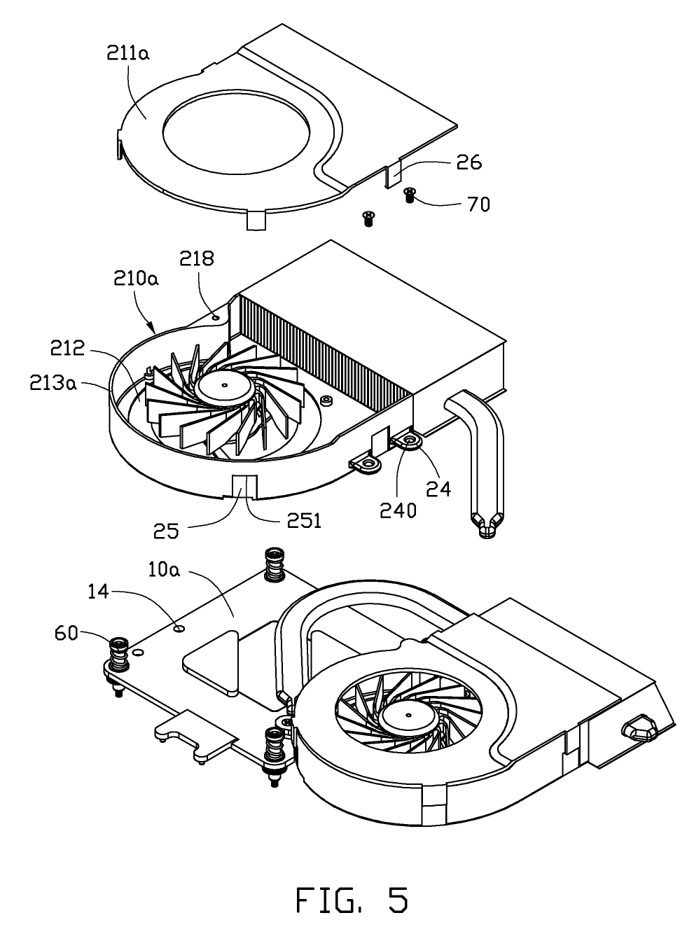

Referring to FIG. 3, the mounting plate 10 is substantially rectangular and made of a metallic material. The mounting plate 10 defines four securing holes 11 in four corners thereof. The securing holes 11 is configured for receiving fasteners 60 (referring to FIG. 5) to secure the mounting plate 10 onto a substrate, such as a printed circuit board. The mounting plate 10 defines a notch 12 in a central portion thereof. The notch 12 is substantially rectangular. The mounting plate 10 further defines an opening 13 above the notch 12. The opening 13 extends through the mounting plate 10 and communicates with the notch 12.

The two heat pipes 50 are flat. Each of the heat pipes 50 includes an evaporation section 51 and a condensation section 52 at two opposite ends thereof. The heat absorbing plate 40 is a rectangular plate made of a highly heat conductive material, such as copper. The heat absorbing plate 40 is received in the notch 12 of the mounting plate 10. An upper surface of the heat absorbing plate 40 is exposed to an outside through the opening 13 of the mounting plate 10. The evaporation sections 51 of the two heat pipes 50 are attached to the upper surface of the heat absorbing plate 40 via the opening 13 of the mounting plate 10. The condensation section 52 of each of the heat pipes 50 extends into a corresponding fin assembly 30.

In the thermal module 100, the fan housings 21 of the centrifugal fans 20 are formed separately from the mounting plate 10, the bases 210 of the fan housings 21 are made of plastic material and the mounting plate is made of metallic material. The centrifugal fans 20 are mounted to the mounting plate 10 by the securing flakes 23 of the fan housings 21, whereby the mould for manufacturing the mounting plate 10 is easy to design and the material cost of the thermal module 100 is relatively reduced. Therefore, the thermal module 100 has a lower manufacture cost. Furthermore, the centrifugal fans 20 are disposed immediately neighboring to the mounting plate 10, to thereby enhance a compactness of the structure of the thermal module 100. Moreover, the centrifugal fans 20 are disposed immediately neighboring to the mounting plate 10 and firmly mounted to the mounting plate 10, which reduces a length of the heat pipe 50 in connecting the heat absorbing plate 40 with the fin assembly 30 and accordingly avoids a possible deformation of the heat pipe 50.

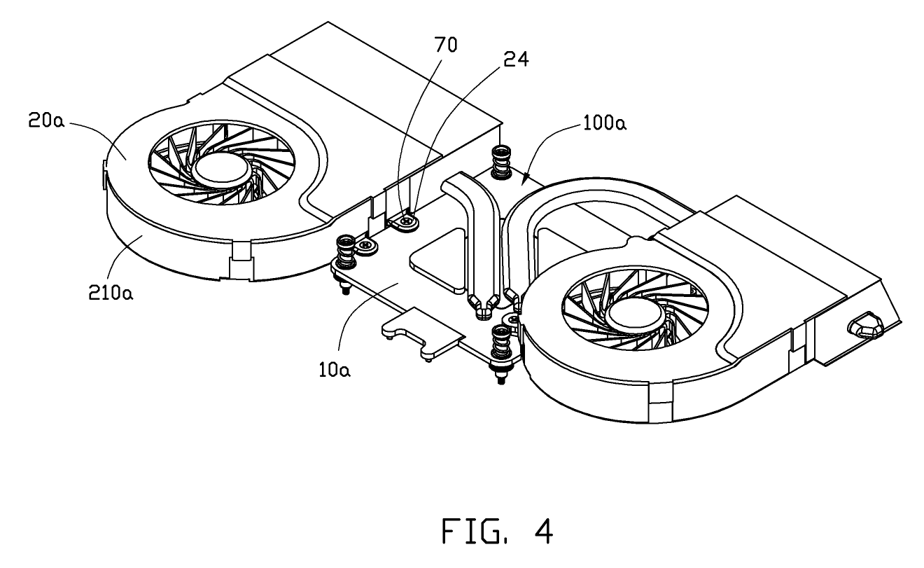

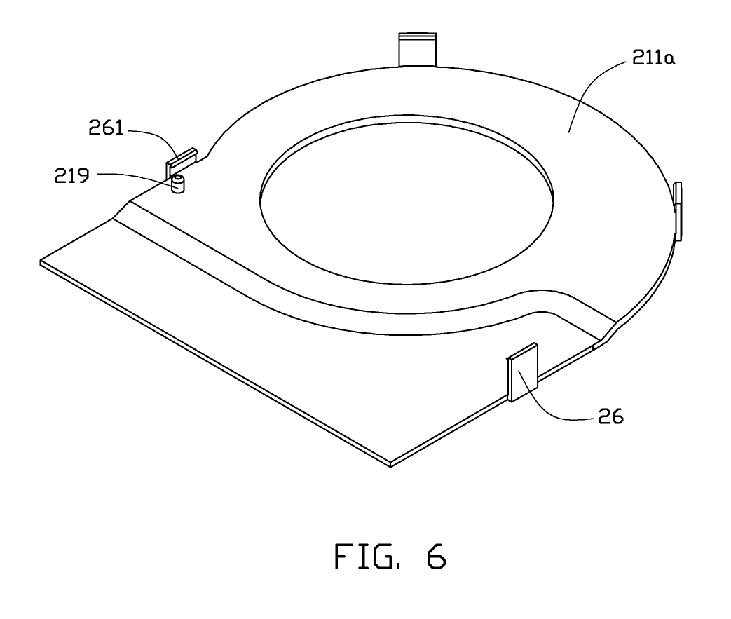

Alternatively, the centrifugal fans 20 can be secured on the mounting plate 10 by other securing structure formed on the centrifugal fans 20. FIG. 4 shows a thermal module 100a according to a second embodiment of the present disclosure. The thermal module 100a is similar to the previous embodiment. The primary difference is that each of the centrifugal fans 20a is mounted to the mounting plate 10a via two mounting ears 24 protruding outwardly from the base 210a of the centrifugal fan 20a. Referring to FIG. 5, each of the mounting ears 24 protrudes outwardly and horizontally from the base 210a of the centrifugal fan 20a towards the mounting plate 10a. Each mounting ear 24 defines a through hole 240 therein. The mounting plate 10a defines four fixing holes 14 therein corresponding to the through holes 240 of the mounting ears 24 of the centrifugal fans 20a. Each through hole 240 of the mounting ear 24 is aligned with a fixing hole 14 of the mounting plate 10a for receiving a fastener 70 to secure the centrifugal fan 20a to the mounting plate 10a. The centrifugal fan 20a is disposed immediately neighboring to the mounting plate 10a and firmly mounted to the mounting plate 10a, which reduces a length of the heat pipe 50 and avoids a deformation of the heat pipe 50. The side wall 213a of the base 210a of each centrifugal fan 20a defines a plurality of recesses 25 in an outer surface thereof. Each of the recesses 25 extends upwardly from the bottom plate 212 towards a middle portion of the side wall 213a, whereby a step 251 is formed at the middle portion of the side wall 213a in the recess 25. The side wall 213a of the centrifugal fan 20a defines a blind hole 218 in a top end thereof. The cover 211a of the centrifugal fan 20a protrudes a plurality of clasping flakes 26 downwardly from an outer edge thereof corresponding to the recesses 25 of the side wall 213a of the base 210a. Referring to FIG. 6, each of the clasping flakes 26 protrudes a hook portion 261 horizontally and inwardly from a free end thereof. Corresponding to the blind hole 28 of the side wall 213a of the base 210a, the cover 211a of the centrifugal fan 20a protrudes a pole 219 downwardly therefrom. The hook portion 261 of each of the clasping flakes 26 engages with the step 251 of a corresponding recess 25 of the side wall 213a, and the pole 219 of the cover 211a is received in the blind hole 218 of the side wall 213a of the base 210a, to thereby secure the cover 211a on the base 210a.

It is to be understood that even though numerous characteristics and advantages of the disclosure have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A thermal module comprising:
a mounting plate;
a centrifugal fan comprising a fan housing and an impeller rotatably received in the fan housing, the fan housing being disposed immediately neighboring to the mounting plate, the fan housing being mounted to a lateral side of the mounting plate via a securing structure formed between the fan housing and the mounting plate;
a fin assembly arranged at an air outlet of the centrifugal fan; and
a heat pipe connecting the mounting plate with the fin assembly.

2. The thermal module of claim 1, wherein the fan housing comprises a base and a cover covering on the base, the mounting plate is made of a metallic material, the base of the centrifugal fan is made of a plastic material.

3. The thermal module of claim 2, wherein the cover is made of a metallic material, the securing structure comprises a securing flake formed at an outer edge of the cover, the securing flake comprises an arm portion extending downwardly from the outer edge of the cover and a securing portion extending perpendicularly outwardly form a bottom end of the arm portion towards the mounting plate, and the securing portion of the securing flake is secured on the mounting plate.

4. The thermal module of claim 3, wherein the arm portion protrudes a rib therefrom, the rib is strip-shaped and extends linearly from a top end of the arm portion towards the bottom end of the arm portion.

5. The thermal module of claim 2, wherein the securing structure comprises a plurality of mounting ears extending outwardly from the base of the fan housing toward the mounting plate, each of the mounting ears defines a through hole therein, and the fan housing is secured to the mounting plate through fasteners extending through the through holes of the mounting ears and engaging with the mounting plate.

6. The thermal module of claim 5, wherein the base comprises a bottom plate and a side wall extend upwardly from an outer periphery of the bottom plate, the side wall defines a plurality of recesses in an outer surface thereof, each recess extends upwardly from the bottom plate towards a middle portion of the side wall to form a step at the middle portion of the side wall, the cover of the centrifugal fan extends a plurality of clasping flakes downwardly from an outer edge thereof, each clasping flake protrudes a hook portion horizontally and inwardly from a free end thereof, and the hook portion of each clasping flake engages with the step of a corresponding recess of the side wall.

7. The thermal module of claim 5, wherein the side wall defines a blind hole in a top end thereof, the cover protrudes a pole downwardly therefrom, and the pole of the cover is received in the blind hole of the side wall.

8. The thermal module of claim 2, further comprising another centrifugal fan, the another centrifugal fan comprising a fan housing and an impeller rotatably received in the fan housing of the another centrifugal fan, the fan housing of the another centrifugal fan comprising a base and a cover covering on the base of the another centrifugal fan, the base of the another centrifugal fan being made of a plastic material and disposed immediately neighboring to the mounting plate, the fan housing of the another centrifugal fan being secured to an opposite lateral side of the mounting plate via a securing structure formed between the fan housing of the another centrifugal fan and the mounting plate.

9. The thermal module of claim 2, further comprising a heat absorbing plate attached to the mounting plate, the heat pipe connecting the heat absorbing plate with the fin assembly.

10. The thermal module of claim 9, wherein the mounting plate defines an opening above the heat absorbing plate, and the heat pipe is attached to an upper surface of the heat absorbing plate through the opening of the mounting plate.

11. The thermal module of claim 10, wherein the mounting plate defines a notch in a bottom surface thereof for receiving the heat absorbing plate therein, and the opening communicates with the notch.
